(19) United States
(12) Patent Application Publication
(10) Pub. No.: US 2008/0011654 A1
(43) Pub. Date: Jan. 17, 2008

(54) Mail processing system with radiation filtering

(76) Inventors: Mathew S. Hale, Barton, NY (US); Mark D. Goodwin, Apalachin, NY (US)

Correspondence Address: Lockheed Martin Corporation;c/o WOLF, GREENFIELD & SACKS, P.C., 600 ATLANTIC AVENUE, BOSTON, MA, 02210-2206, US

(21) Appl. No.: 11/824,828

(22) Filed: Jul. 3, 2007

Related U.S. Application Data
(60) Provisional application No. 60/819,136, filed on Jul. 7, 2006.
(60) Provisional application No. 60/819,414, filed on Jul. 7, 2006.
(60) Provisional application No. 60/819,217, filed on Jul. 7, 2006.
(60) Provisional application No. 60/819,084, filed on Jul. 7, 2006.
(60) Provisional application No. 60/819,137, filed on Jul. 7, 2006.
(60) Provisional application No. 60/819,188, filed on Jul. 7, 2006.

(51) Int. Cl. G06K 9/00

(52) U.S. Cl. 209/584

(57) ABSTRACT

A mail processing system with a UV imaging subsystem that uses radiation filtering for improved reliability in processing mail. The UV imaging subsystem has one or more filters, such as a short pass filter between a UV radiation source and a mailpiece under examination or long pass filter between the mailpiece and a detector array. The UV subsystem can quickly and reliably form UV images. Though the images are of low resolution, the image quality is adequate to allow the system to identify features—such as barcodes, IBI and stamps—on mailpieces. The image quality is also sufficient to allow the mail processing system to make mail processing decisions—such as whether to invert the mailpiece or where to spray a cancellation mark—as mailpieces are passing through the mail processing system.

### CROSS-REFERENCE TO RELATED APPLICATIONS

This application claims the benefit under 35 U.S.C. § 119(e) of U.S. Provisional Application Ser. No. 60/819,136, filed Jul. 7, 2006, U.S. Provisional Application Ser. No. 60/819,414, filed Jul. 7, 2006, U.S. Provisional Application Ser. No. 60/819,217, filed Jul. 7, 2006, U.S. Provisional Application Ser. No. 60/819,084, filed Jul. 7, 2006, U.S. Provisional Application Ser. No. 60/819,137, filed Jul. 7, 2006, and U.S. Provisional Application Ser. No. 60/819,188, filed Jul. 7, 2006. Each of the above applications is incorporated herein by reference.

### FIELD OF INVENTION

This invention relates generally to mail processing systems and equipment used therein.

### BACKGROUND

The U.S. Postal Service (USPS) has developed standards for the marking of mailpieces that facilitate the automatic sorting and processing of such items. Such mailpiece features include stamps, meter marks, information based indicia (IBI) barcodes (PDF417 and Data Matrix), facing identification marks (FIM), Postal Numeric Encoding Technique (POSTNET) codes, postal alphanumeric encoding technique (PLANET) codes, 4CB codes, and identification (ID) tags. The purpose and use of such features are well known in the art and thus will not be described in detail.

Line scan cameras have been implemented in numerous industrial and commercial settings, such as on high-speed mail sorting systems. An example of a prior art mail sorting system that employed such cameras, as well as several other components, is illustrated in FIG. 1. As shown, the mail sorting system 2 comprised a singulation stage 4, a first indicia detection stage 6, a facing inversion stage 8, a second indicia detection stage 10, a cancellation stage 12, an inversion stage 14, an ID tag spraying stage 16, an image lifting stage 18, and a stacking stage 20. One or more conveyors (not shown) would move mailpieces 19 from stage to stage in the system 2 (from left to right in FIG. 1) at a rate of approximately 3.6-4.0 meters per second.

The singulation stage 4 included a feeder pickoff 22 and a fine cull 24. The feeder pickoff 22 would generally follow a mail stacker (not shown) and would attempt to feed one mailpiece at a time from the mail stacker to the fine cull 24, with a consistent gap between mailpieces. The fine cull 24 would remove mailpieces that were too tall, too long, or perhaps too stiff. When mailpieces 19 left the fine cull 24, they would ideally be in one of four possible orientations, as illustrated by mailpieces 19a-d.

Each of the first and second indicia detection stages 6, 10 included a pair of indicia detectors 26a-b, 26c-d positioned to check the lower edges (of approximately 1 inch) of the opposite faces of a passing mailpiece 19 for reactance to ultraviolet (UV) radiation and for FIM marks, and thereby detect indicia at such locations. As used herein, “indicia” refers to any marking on a mailpiece that represents a postage value. If the first indicia detection stage 6 failed to detect any indicia on either lower edge of a given mailpiece, that mailpiece would be inverted by an inverter 9 at the facing inversion stage 10 so as to allow the second indicia detection stage 10 to check the lower one inch edges of the other side of the mailpiece for indicia. As a result, each mailpiece 19 that had detectable indicia thereon ideally ended up positioned with the edge containing the indicia (the “top edge” of the mailpiece) facing downward after it left the second indicia detection stage 10, with at least one of the indicia detectors 26a-d having identified the face of the mailpiece that contained the indicia.

The cancellation stage 12 included a pair of cancellers 28a-b arranged to spray one side of the top edge of the mailpiece (i.e., the side determined to contain the indicia), and thereby cancel the indicia. Following the cancellation stage 12, each mailpiece would be inverted by an inverter 15 at the inversion stage 14 so that the top edge of the mailpiece was made to face upwards. The ID tag spraying stage 16 included a pair of ID tag sprayers 30a-b arranged to spray an ID tag, as needed, along an appropriate one of the two lower edges of the mailpiece, as determined by the facing decision made by the indicia detection stages 6, 10.

The image lifting stage 18 included a pair of line scanning cameras 32a-b that imaged the mailpiece. Each line scanning camera provided a two hundred and twelve pixel per inch (PPI) image for address recognition. An analysis of the accumulated images facilitated a determination of the one of several output bins 34a-g of the stacking stage 20 into which the mailpieces was to be stacked based on certain criteria.

### SUMMARY

In one aspect, the invention relates to a mail processing system that has a mail conveyor and an array of detector elements facing the mail conveyor. A radiation source emits ultraviolet radiation at the mail conveyor through a short pass filter positioned between the radiation source and the mail conveyor.

In another aspect, the invention relates to a mail processing system that has a mail conveyor and an array of detector elements facing the mail conveyor. A radiation source emit ultraviolet radiation directed at the mail conveyor through a short pass filter having a cutoff wavelength below about 450 nm positioned between the radiation source and the mail conveyor. A long pass filter having a cutoff wavelength above about 400 nm is positioned between the mail conveyor and the array of detector elements.

In a further aspect, the invention relates to a method of operating a mail processing system. Radiation having components in at least a first and second wavelength range is generated. The radiation is filtered to reduce the portion of radiation in the second wavelength range relative to the first wavelength range. A mailpiece is exposed to the filtered radiation and an image of the mailpiece is captured using radiation in the first wavelength range.

### BRIEF DESCRIPTION OF THE DRAWINGS

FIG. 1 is a diagram of a prior art mail sorting system;

FIG. 2 is a diagram of an illustrative example of a mail sorting system in which embodiments of the invention may be implemented;

FIG. 3 is a diagram of another illustrative example of a mail sorting system in which embodiments of the invention may be implemented;

FIG. 4 shows a partial-cutaway, perspective view of the image lifting stage of the system shown in FIGS. 2 and 3;

FIG. 5 shows a top view of the image lifting stage shown in FIG. 4;

FIG. 6 shows a partial-cutaway, perspective view of one of the camera assemblies shown in FIG. 4;

FIG. 7 shows a top view of the camera assembly shown in FIG. 6;

FIG. 8 shows an exploded view of the camera-assembly shown in FIG. 6;

FIG. 9 shows an exploded view of the nose assembly portion of the camera assembly shown in FIG. 6;

FIG. 10 shows a partial-cutaway, perspective view of the base assembly portion of the camera assembly shown in FIG. 6;

FIGS. 11 and 12 show a low-resolution UV image of a mailpiece with a UV-reactive meter mark and a grayscale image of the same mailpiece, respectively, which images were taken by a camera assembly like that shown in FIG. 6;

FIGS. 13 and 14 show a UV image of a mailpiece with a UV-reactive IBI barcode and a grayscale image of the same mailpiece, respectively, which images were taken by a camera assembly like that shown in FIG. 6;

FIGS. 15 and 16 show a UV image of a mailpiece with a UV-reactive ID tag and a grayscale image of the same mailpiece, respectively, which images were taken by a camera assembly like that shown in FIG. 6;

FIG. 17 is a sketch illustrating a UV imaging subsystem according to an embodiment of the invention; and

FIG. 18 is a flowchart of a process for inspecting a mailpiece according to an embodiment of the invention.

### DETAILED DESCRIPTION

We have appreciated that existing mail processing equipment could be improved with improved and differently organized system components. Improvements in the type and organization of components may, for example, increase the speed or accuracy with which mail is sorted. Additionally, improvements may reduce the overall cost and increase the reliability of mail processing equipment.

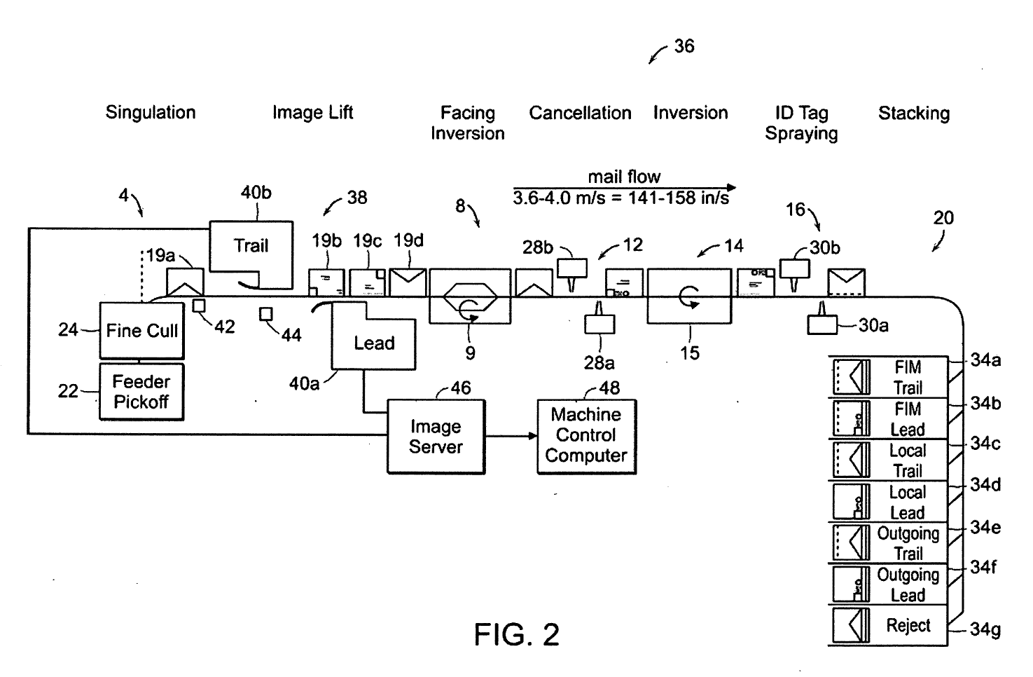

An illustrative example of a mail processing system embodying improved and differently organized components is shown in FIG. 2. In this example, the mail processing system is a mail sorting system in which mailpieces are carried through the system on a mail conveyor, such as a belt or series of belts. As mailpieces pass through the system, they are imaged. The image information may be used for routing the mailpieces to appropriate output locations. In addition, the image information may be used with the mail sorting system for tasks such as determining whether postage is affixed, locating indicia to which a cancellation mark is applied, or positioning a bar code or similar markings on the mailpiece or determining of other markings, features and characteristics of the mailpiece.

Details concerning the structure and operation of mail processing systems according to some embodiments are provided in Application Ser. No. 60/819,136, entitled MULTIPLE ILLUMINATION SOURCES TO LEVEL SPECTRAL RESPONSE FOR MACHINE VISION CAMERA and bearing attorney docket nos. L0562.70061US00 and Application Ser. No. 60/819,084, entitled SYNCHRONIZATION OF STROBED ILLUMINATION WITH LINE SCANNING OF CAMERA and bearing attorney docket nos. L0562.70064US00. Both of which are filed on even date herewith and are incorporated herein by reference in their entireties.

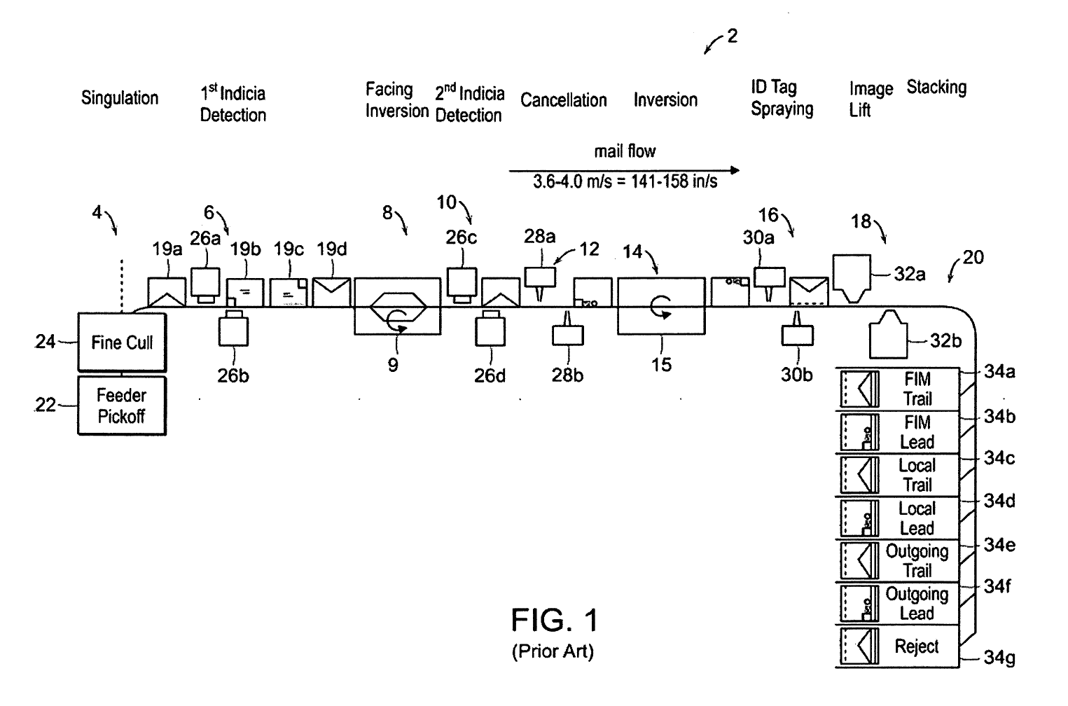

As shown, mail sorting system 36 of FIG. 2 is similar to the mail sorting system 2 of FIG. 1 insofar as it comprises a singulation stage 4, a facing inversion stage 8, a cancellation stage 12, an inversion stage 14, an ID tag spraying stage 16, and a stacking stage 20. In contrast to the system 2, however, in the system 36, all of the functionality of the first indicia detection stage 6, the second indicia detection stage 10, and the image lifting station 18 may be achieved by a single pair of camera assemblies 40a-b (described in more detail below) included in an image lifting stage 38. As shown, the image lifting stage 38 is located between the singulation stage 4 and the facing inversion stage 8 of the system 36, but image lifting stage 38 may be incorporated into system 36 in any suitable location.

In operation, each of the camera assemblies 40a-b acquires both a low-resolution UV image and a high-resolution grayscale image of a respective one of the two faces of each passing mailpiece 19. Because the UV images are of the entire face of the mailpiece, rather than just the lower one inch edge, there is no need to invert the mailpiece when making a facing determination.

Each of the camera assemblies illustrated in FIG. 2 is constructed to acquire both a low-resolution UV image and a high-resolution grayscale image, and such assemblies may be used in embodiments of the invention. It should be appreciated, however, that the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of one or multiple faces of a mailpiece. Similarly, optical processing, such as through the use of mirrors, could allow a single camera assembly to capture images of one or multiple faces of a mailpiece.

Further, it should be appreciated that UV and grayscale are representative of the types of image information that may be acquired rather than a limitation on the invention. For example, a color image may be acquired. As another example, an acquired image may be binarized for processing in some embodiments. In those embodiments, grayscale information need not be collected or retained and each image pixel may be simply represented by a single digital value. Consequently, any suitable imaging components may be included in system 36.

As shown, the system 36 may further include an item presence detector 42, a belt encoder 44, an image server 46, and a machine control computer 48. The item presence detector 42 (examples of an item presence detector are a “photo eye” or a “light barrier”) may be located, for example, five inches upstream of the trail camera assembly 40b, to indicate when a mailpiece is approaching. The belt encoder 44 may output pulses (or “ticks”) at a rate determined by the travel speed of the belt. For example, the belt encoder 44 may output two hundred and fifty six pulses per inch of belt travel. The combination of the item presence detector 42 and belt encoder 44 thus enables a relatively precise determination of the location of each passing mailpiece at any given time. Such location and timing information may be used, for example, to control the strobing of light sources in the camera assemblies 40a-b to ensure optimal performance independent of variations in belt speed.

Image information acquired with the camera assemblies 40a-b or other imaging components may be processed for control of the mail sorting system or for use in routing mailpieces passing through the system 36. Processing may be performed in any suitable way with one or more processors. In the illustrated embodiment, processing is performed by image server 46.

The image server 46 may receive image data from the camera assemblies 40a-b, and process and analyze such data to extract certain information about the orientation of and various markings on each mailpiece. In some embodiments, for example, images may be analyzed using a neural network, a pattern analysis algorithm, or a combination thereof. Either or both of the grayscale images and the UV images may be so processed and analyzed, and the results of such analysis may be used by other components in the system 36, or perhaps by components outside the system, for sorting or any other purpose.

In the embodiment shown, information obtained from processing images is used for control of components in the system 36 by providing that information to a separate processor that controls the system. The information obtained from the images, however, may additionally or alternatively be used in any other suitable way for any of a number of other purposes. In the pictured embodiment, control for the system 36 is provided by a machine control computer 48. Though not expressly shown, the machine control computer 48 may be connected to any or all of the components in the system 36 that may output status information or receive control inputs. The machine control computer 48 may, for example, access information extracted by the image server 46, as well as information from other components in the system, and use such information to control the various system components based thereupon.

Details concerning particular algorithms executed by the image server 46 and other hardware or firmware in the system are provided in application Ser. Nos. 11/482,386, 11/482,418, 11/482,421, 11/482,423, and 11/482,561, filed on even date herewith, respectively entitled DETECTION AND IDENTIFICATION OF POSTAL INDICIA, SYSTEM AN METHOD FOR REAL-TIME DETERMINATION OF THE ORIENTATION OF AN ENVELOPE, ARBITRATION SYSTEM FOR DETERMINING THE ORIENTATION OF AN ENVELOPE FROM A PLURALITY OF CLASSIFIERS, DETECTION AND IDENTIFICATION OF POSTAL METERMARKS, POSTAL INDICIA CATEGORIZATION SYSTEM, and bearing attorney docket nos., LM(F)8227, LM(F)8228, LM(F)8229, LM(F)8230, LM(F)8231. Each of the foregoing applications is incorporated herein by reference in its entirety.

In the example shown, the camera assembly 40a is called the “lead” assembly because it is positioned so that, for mailpieces in an upright orientation, the indicia (in the upper right hand corner) is on the leading edge of the mailpiece 19 with respect to its direction of travel. Likewise, the camera assembly 40b is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 40a, the image server 46 may determine an orientation of “flip” or “no-flip” for the inverter 9. In particular, the inverter 9 is controlled so that that each mailpiece 19 has its top edge down when it reaches the cancellation stage 12, thus enabling one of the cancellers 28a-b to spray a cancellation mark on any indicia properly affixed to a mailpiece by spraying only the bottom edge of the path (top edge of the mailpiece). The image server 46 may also make a facing decision that determines which canceller (lead 28a or trail 28b) should be used to spray the cancellation mark. Other information recognized by the image server 46, such as IBI, may also be used, for example, to disable cancellation of IBI postage since IBI would otherwise be illegible downstream.

After cancellation, all mailpieces may be inverted by the inverter 15, thus placing each mailpiece 19 in its upright orientation. Immediately thereafter, an ID tag may be sprayed using one of the ID tag sprayers 30a-b that is selected based on the facing decision made by the image server 46. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces 19 may ride on extended belts for drying before being placed in output bins or otherwise routed for further processing. In the example shown, there are seven output bins 34a-g. Except for rejects (bin 34g), the output bins 34a-f are in pairs to separate lead mailpieces from trail mailpieces. It is desirable for the mailpieces 19 in each output bin to face identically. The operator may thus rotate trays properly so as to orient lead and trail mailpieces the same way. The mail may be separated into four broad categories: (1) FIM A&C (FIM with POSTNET), (2) outgoing (destination is a different SCF), (3) local (destination is within this SCF), and (4) reject (detected double feeds, not possible to sort into other categories). The decision of outgoing vs. local, for example, may be based on the image analysis performed by the image server 46.

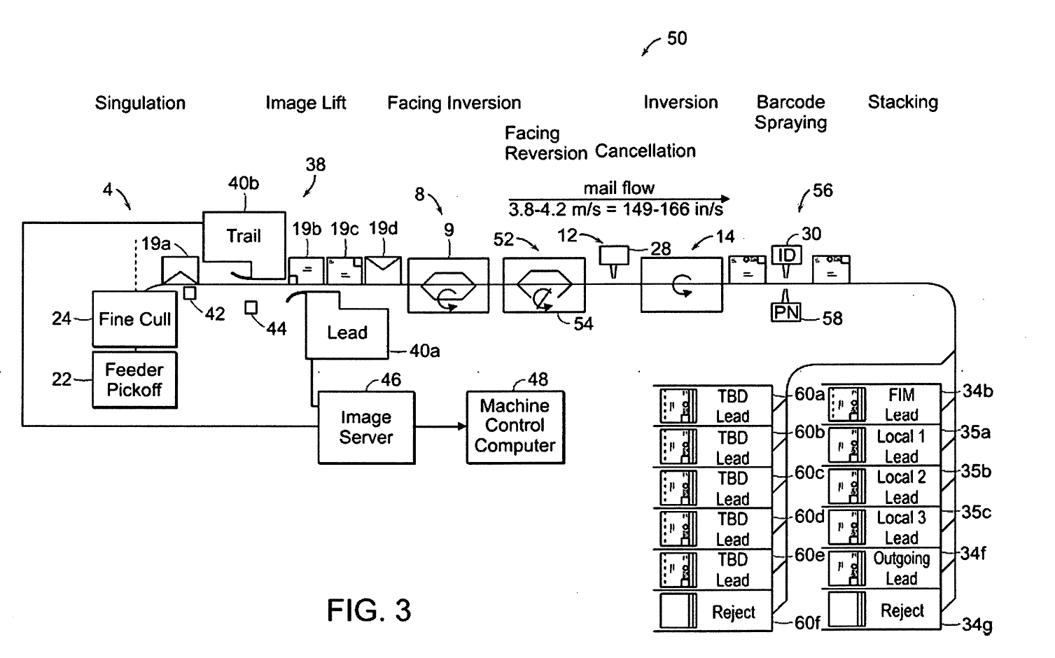

FIG. 3 shows another illustrative example of a mail sorting system embodying various aspects of the invention. The system 50 of FIG. 3 is similar to the system 36 of FIG. 2, but there are a few significant differences. One such difference is that the system 50 includes a facing reversion stage 52 (including a reverser 54) in addition to the facing inversion stage 8. The reverser 54 may be used to ensure that all mailpieces 19 are in the same orientation before they reach the cancellation stage 12 by selectively reversing (flipping horizontally) those mailpieces that are facing opposite the desired direction. Because all mailpieces are known to have the same orientation when they reach the cancellation stage 12, it is possible to employ only a single cancellation sprayer 28 in that stage.

Another difference between the system 50 of FIG. 3 and the system 36 of FIG. 2 is that, in the system 50, a barcode spraying stage 56 includes a single ID tag sprayer 30 as well as a single POSTNET sprayer 58, whereas, in the system 30, the ID tag spraying stage 16 included a pair of ID tag sprayers 30a-b. Again, the provision of the facing reversion stage 52 enables only a single sprayer of each type to be employed, because the precise orientation of all passing mailpieces 19 is known (i.e., they are all in a lead orientation).

Because it is known that all mailpieces are in a lead orientation, there is also no need for separate bins for lead and trail mailpieces, like in the embodiment of FIG. 2. In the example shown, three separate local lead bins 35a-c are employed in lieu of the trail bins 34a, 34c, and 34e of the system 36, thus enabling a finer level of sorting of local mail by the system 50. The system 50 also includes several additional output bins 60a-f into which mail can be sorted depending on the analysis done by the image server 46 on UV and/or grayscale images accumulated by the camera assemblies 40a-b.

As illustrated by the embodiments of a mail processing system shown in FIGS. 2 and 3, it is desirable for decisions to be made as a mailpiece passes through the system. The speed and accuracy with which the information to make such decisions can be acquired and processed can impact the overall speed and accuracy of the entire mail processing system. In the illustrated embodiments, both the speed and accuracy of mail processing is improved with an improved image lifting stage 38.

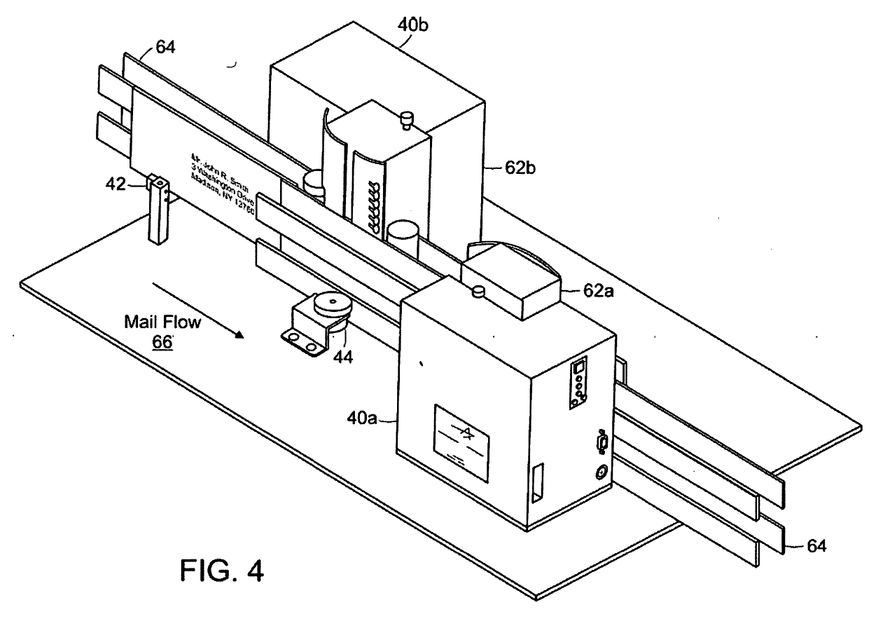

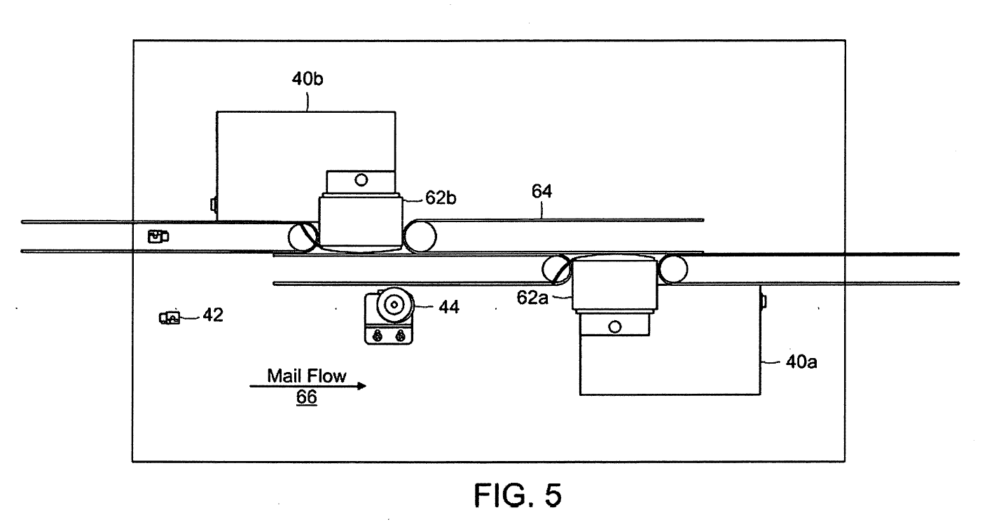

FIGS. 4 and 5 shown perspective and top views of an illustrative example of an improved image lifting stage 38 that may be used in the systems illustrated in each of FIGS. 2 and 3 or in other suitable mail processing applications. In FIG. 4, portions of the housings for the camera assemblies 40a-b have been removed. As shown, several conveyor belts 64 are arranged to move a mailpiece 19 past nose assemblies 62a-b of the camera assemblies 40a-b in the direction of the arrow 66 so that the camera assemblies 40a-b can acquire images thereof. Ideally, the faces of the mailpieces 19 are caused to maintain physical contact with the front portions of the nose assemblies 62a-b during the imaging process so that the distance between the camera and the mailpiece is kept constant.

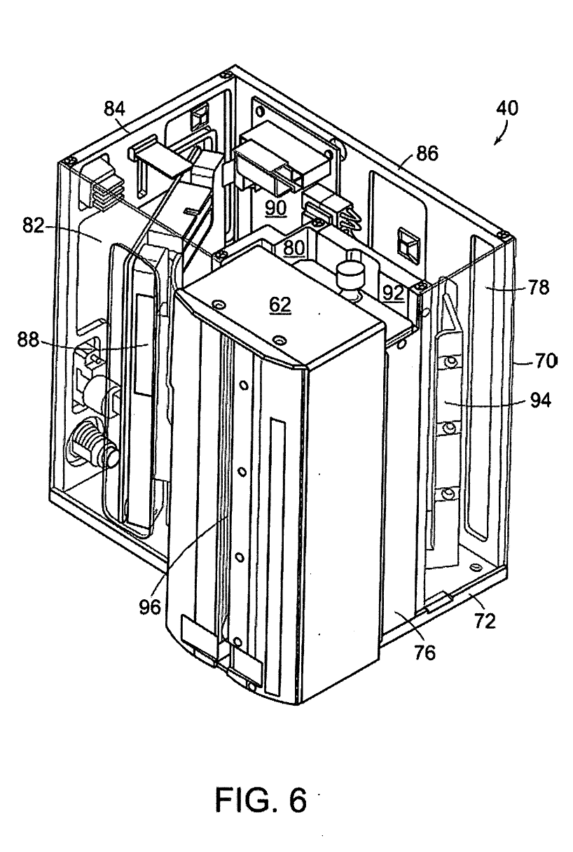

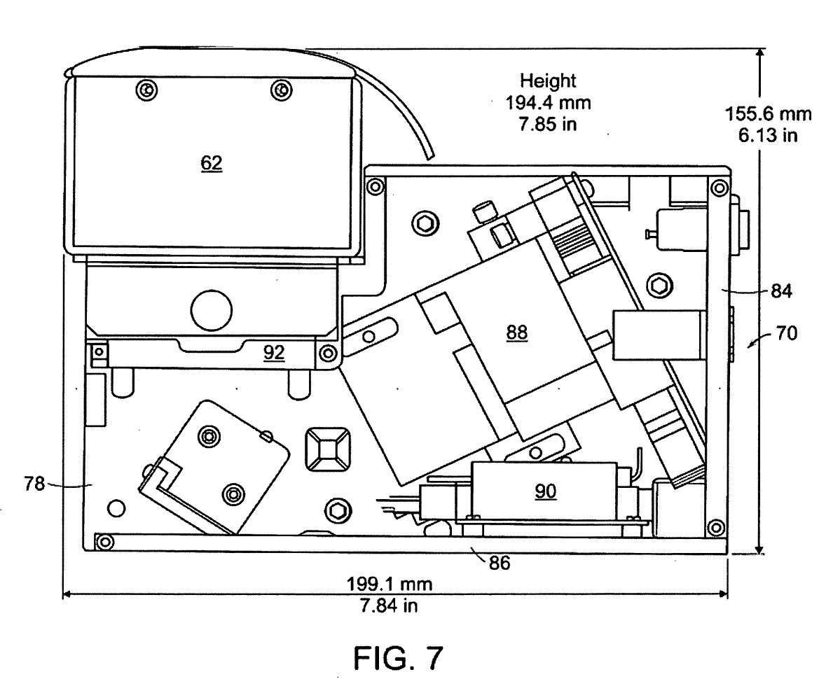

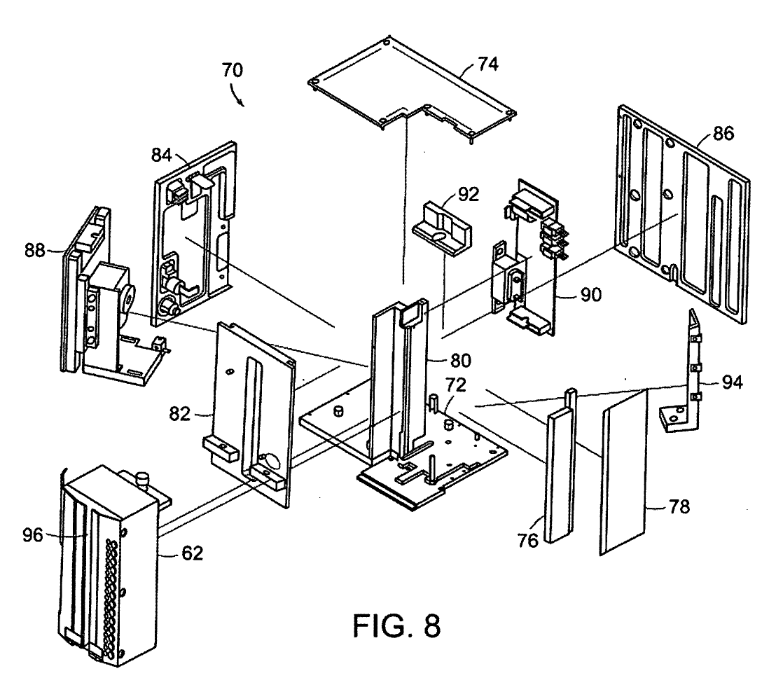

Several views of an illustrative embodiment of a camera assembly 40, and components thereof, are shown in FIGS. 6-10. As shown, each camera assembly 40 may comprise a nose assembly 62 detachably mounted to a base assembly 70. The base assembly 70 may comprise a housing formed of a base plate 72, top cover 74, and panels 76, 78, 80, 82, 84, 86. These panels may act as a housing to enclose the components of the assembly. These panels may additionally or alternatively serve as part of the support structure for components of the assembly.

In the example shown, enclosed within the housing are an optical bench assembly 88, a camera interface board (CIB) 90, a connector 92 for the nose assembly 62, and a mirror assembly 94. The optical bench assembly may, for example, contain an imaging array, such as a charge coupled device (CCD) (not shown), that produces lines of a grayscale image representative of the intensity of light transmitted through a slit 96 in the front of the nose assembly 62 and reflected from the mirror 94 onto the CCD of the optical bench assembly 88. Since the structure and function of the optical bench assembly 88 is essentially the same as that described in United States Application Publication No. 2006/0120563 A1, which is incorporated herein by reference in its entirety, the details of that structure will not be further described. It should be appreciated, however, that any of the other features or functionality of the camera assemblies, components thereof, and systems described in that published application may additionally or alternatively be employed in connection with various embodiments of the camera assemblies and overall system described herein.

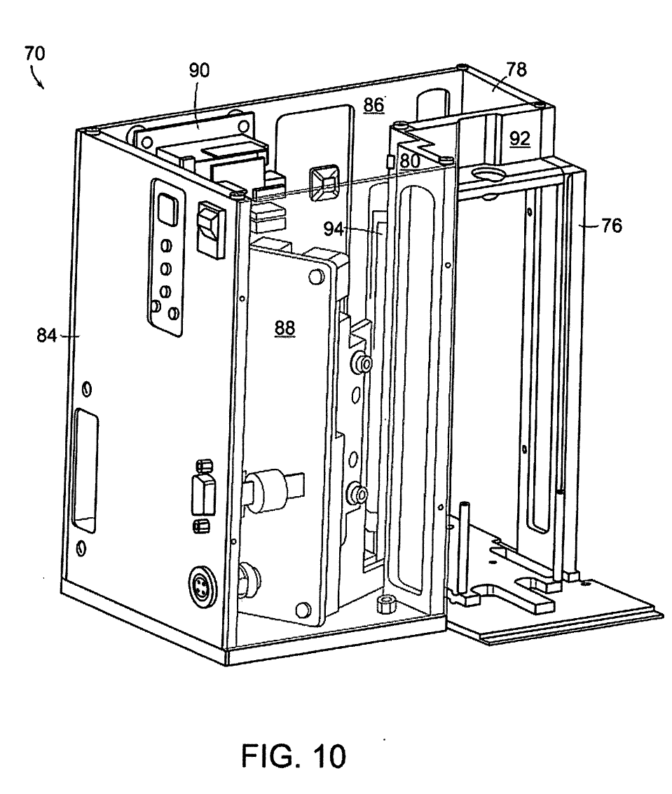

The CIB 90 may provide an electrical and communications link amongst the optical bench assembly 88, the nose assembly 62, and external devices (not shown in FIGS. 6-10). Such external devices may, for example, communicate with the camera assembly components via ports on the back panel 84 (see FIG. 10). The CIB 90 may, for instance, communicate UV and/or grayscale image data to the image server 46 (see FIGS. 2 and 3) via one or more Cameralink connections. In some embodiments, moreover, the CIB 90 may receive inputs from the item presence detector 42 and belt encoder 44 (shown in FIGS. 2 and 3), and selectively control activation of illumination sources and image acquisition components so as to accurately acquire high-quality images of a proper resolution, independent of changes in belt speed. Further details concerning an illustrative apparatus and technique for controlling the illumination source based on belt speed are provided below in connection with 19-22.

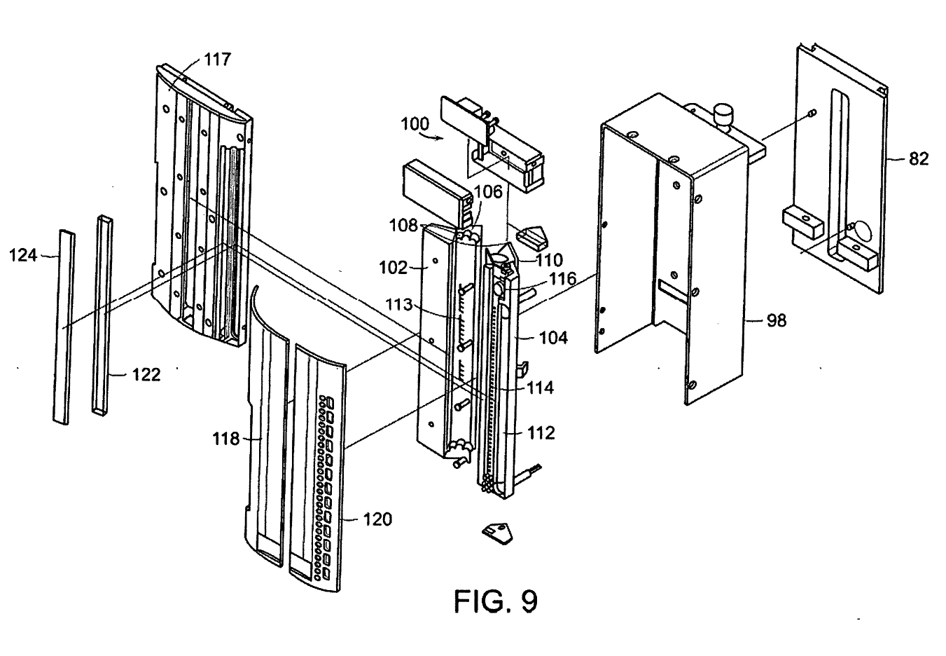

FIG. 9 shows an exploded view of an illustrative embodiment of the nose assembly 62. As shown, the nose assembly 62 may comprise a housing 98 in which are disposed a power supply 100 for a source of UV radiation 112 (discussed below), and a pair of aluminum support members 102, 104 having various components disposed thereon. In the example shown, the support member 102 supports a light source, which is here shown as an LED assembly 106. LED assembly 106 may be constructed from a circuit board or other suitable substrate having disposed thereon a large number of light emitting diodes (LEDs) 108. Likewise the support member 104 may support a similar LED assembly 110, which may also contain a circuit board and may also having a large number of LEDs 108 disposed thereon. The LED assemblies 106, 110 may be identical, but such is not required. In the illustrative embodiment shown, twenty nine rows of three LEDs 108 are disposed on each of the LED assemblies 106, 110, and a diffuser 113 is disposed in front of each group of eighty seven LEDs 108. In some embodiments, LEDs of different colors may be included amongst the white LEDs, and in some embodiments may be selectively controlled, so as to improve the response spectrum of the camera system.

As shown, the aluminum support member 104 may also support a source of UV radiation 112 and an array of phototransistors 114 arranged to receive light reflected from a mailpiece exposed to UV radiation from the source 112. In the example shown, the UV radiation source 112 is a florescent tube, but a set of UV generating diodes, or any other UV generating means, could alternatively be employed as the source of UV radiation 112. In some embodiments, the phototransistors 114 (or some other simple photon receptors) each contain an integrated lens, thus eliminating the need for focusing and calibration. Additional details concerning the structure and operation of the UV radiation source 112 and phototransistors 114 are provided in Application Ser. No. 60/819,188, entitled MAIL PROCESSING SYSTEM WITH LOW RESOLUTION UV IMAGING SUBSYSTEM, bearing attorney docket number L0562.70067US00 and filed on even date herewith, which is incorporated herein by reference in its entirety. Moreover, details concerning the control of the UV radiation source 112 so that it is shut off during periods of non-use of the system or when the housing assembly is opened or has been compromised are provided in Application Ser. No. 60/819,414, entitled MAIL IMAGING SYSTEM WITH UV ILLUMINATION INTERRUPT, bearing attorney docket number L0562.70062US00, and filed on even date herewith, which is incorporated herein by reference in its entirety. In the example shown, analog outputs of the phototransistors 114 are provided to an analog-to-digital converter (ADC) 116 where they are converted to a digital signal prior to being fed to the CIB 90 for further processing.

In the embodiment shown, the aluminum support members 102, 104 and associated components are covered by a platen 117 having a specialized configuration. The platen 117, in turn, is covered by a pair of wear plates 118, 120 also having a specialized design. Details concerning the specialized structure and function of the platen 117 and wear plates 118, 120 are provided in Application Ser. No. 60/819,217, entitled MAIL IMAGING SYSTEM WITH SECONDARY ILLUMINATION/IMAGING WINDOW, bearing attorney docket number L0562.70063US00, and filed on even date herewith, which is incorporated herein by reference in its entirety.

As shown, the UV radiation source 112 and array of phototransistors 114 may each be covered by a respective filter 122, 124 to enhance the accuracy of the UV image acquisition. In the embodiment shown, performance is enhance by placing a short pass filter 122 (allowing UV radiation to pass and blocking visible illumination) in front of the UV radiation source 112, and placing a long pass filter (allowing visible radiation to pass and blocking UV radiation) in front of the array of phototransistors 114.

The radiation source 112 and array of phototransistors 114 may be arranged so that their operation does not interfere with the operation of optical bench assembly 88 in acquiring grayscale images. Advantageously, however, because they are acquired by components within the same camera assembly 40, the UV images and grayscale images acquired by the different components can be correlated with one another to facilitate the identification of the various markings on scanned mailpieces. Additional details concerning the acquisition and use of dual images by a camera assembly 40 and related components are provided in Application Ser. No. 60/819,137, entitled MAIL PROCESSING SYSTEM WITH DUAL CAMERA ASSEMBLY, bearing attorney docket number L0562.70066US00 and filed on even date herewith, which is incorporated herein by reference in its entirety.

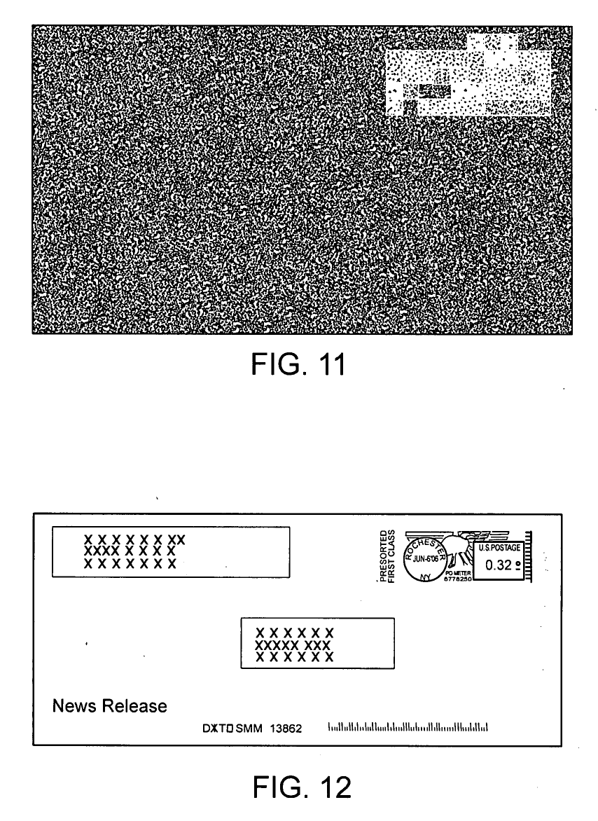

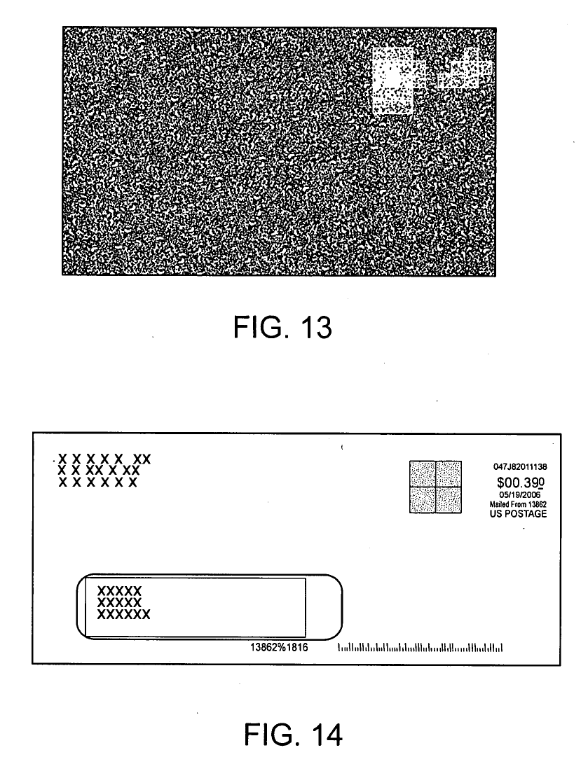

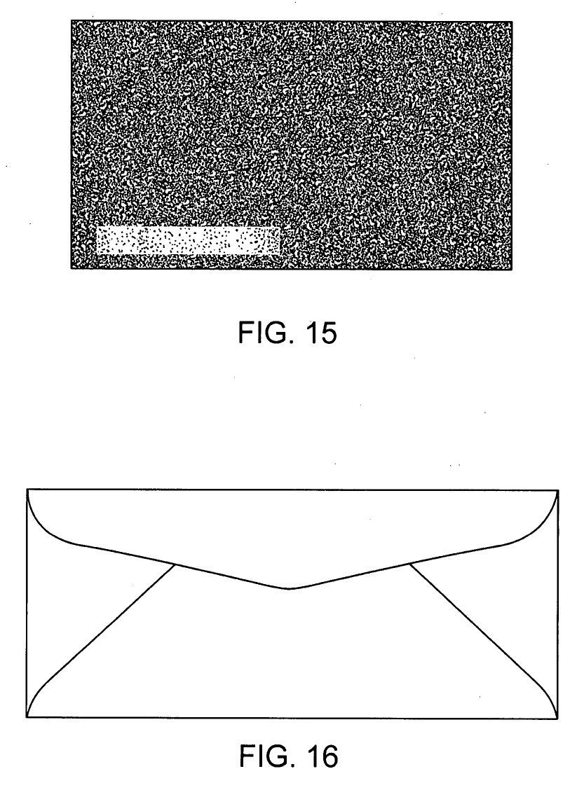

Examples of UV and grayscale images acquired of mailpieces by one of the camera assemblies 40 are shown in FIGS. 11-16, with names and addresses redacted where legible. In particular, FIG. 11 shows a low-resolution UV image of a mailpiece with a UV-reactive meter mark, and FIG. 12 shows a grayscale image of the same mailpiece. Similarly, FIG. 13 shows a UV image of a mailpiece with a UV-reactive IBI barcode, and FIG. 14 shows a grayscale image of the same mailpiece. Finally, FIG. 15 shows a UV image of a mailpiece with a UV-reactive ID tag, and FIG. 16 shows a grayscale image of the same mailpiece.

While forming a UV image of a mailpiece can provide fast and reliable processing of mailpieces, we have appreciated that light filtering may further improve processing of mailpieces when imaged using UV light. As shown above in FIG. 9, one or more filters may be used in conjunction with a camera assembly forming a UV image. We have appreciated that filters provide a relatively low cost way to increase the signal to noise ratio of an image formed with UV radiation, which can in turn reduce the amount of processing required on the image or increase the reliability of a determination made based on processing of the UV image. The net result may be improved reliability in processing of mailpieces.

In the embodiment of FIG. 9, two radiation filters are shown: source filter 122 and detector filter 124. In the embodiment shown, each filter is implemented as a single piece, with source filter 122 positioned along the entire length of UV radiation source 112 so that light from UV radiation source 112 radiating towards a mailpiece under inspection will pass through source filter 122. Detector filter 124 positioned along the entire length of the array of phototransistors 114 so that light emanating from a mailpiece under inspection will pass through detector filter 124 before reaching the detector. Accordingly, each filter is elongated, with generally the same aspect ratio as the source and detector.

However, other suitable sizes and shapes of filters may be used. For example, either or both of the source filter and detector filter may be formed from one or more components similarly positioned so that light radiating towards or from, respectively, a mailpiece under inspection will pass through the filter. For example, in embodiments in which the detector is formed from multiple discrete elements, such as phototransistors 114, detector filter 124 may be formed from a similar number of discrete components, each filter component positioned adjacent a detector element. Similarly, in embodiments in which UV radiation source 112 is formed from an array of discrete elements, such as LEDs, source filter 122 may be formed from a similar number of discrete components, each filter component positioned adjacent a source element.

In the embodiment of FIG. 9, source filter 122 and detector filter 124 are both mounted to support member 104. As pictured, support member 104 also holds UV radiation source 112 and phototransistors 114. In addition, support member 104 acts as a light baffle, preventing light from emanating from UV radiation source 112 without passing through source filter 122 or from reaching the detector without passing through detector filter 124. However, it is not a limitation on the invention that the light filters be supported in the same structure that supports the source and detector and any suitable support mechanism for source filter 122 and detector filter 124 may be used.

In the illustrated embodiment, source filter 122 and detector filter 124 are both refractive filters that selectively attenuate radiation passing through them based on the wavelength of that radiation. Refractive filters are used in some known optical systems, such as photographic systems. Accordingly, suitable filter material may be procured commercially. For example, either or both of source filter 122 and detector filter 124 may be fabricated from filter glass available from Hoya Corporation USA of San Jose, Calif.

However, it is not necessary that the filters be formed of glass. A refractive filter may be formed from any suitable material, including plastic such as polycarbonate or acrylic, and may be doped with any suitable organic or inorganic materials to provide a desired attenuation versus wavelength characteristic to the filter. Though glass and plastic are relatively soft and may be scratched as mailpieces pass camera assembly 40, such materials may be suitable for some embodiments, such as those in which the filter material is mounted in a way that avoids abrasion of the filter material. In the embodiment of FIG. 9, both filters 122 and 124 are mounted behind wear plate 120, which prevents direct contact of the mailpieces with the filters and reduces abrasion of the filters. Further, as shown FIG. 9, the filters may be mounted on surface of the faceplate of the camera assembly that is set back from or angled away from the path of mailpieces under inspection. As shown, the portion of the surface of wear plate 120 in which filters 122 and 124 are mounted is angled at an angle of between about 2 degrees and 10 degrees relative to the path of mailpieces through the mail processing system, with some embodiments mounted at an angle between about 5 degrees and about 10 degrees.

In other embodiments, it may be desirable to construct either or both of source filter 122 and detector filter 124 from a material that is harder than glass. Materials with a crystal structure, such as sapphire, may be used to construct the filters.

It is not a limitation on the invention that filters be refractive filters. Either or both of source filter 122 and detector filter 124 may be formed using other filtering techniques, including reflective filters.

Also, in some embodiments, either or both of the filters may be incorporated in other elements. For example, in embodiments, a diffuser may be positioned over UV radiation source 112. A diffuser with filtering properties may be used in stead of a separate diffuser and filter. As another alternative, each of the phototransistors 114 may include a lens. Detector filter 124 may be implemented within the lenses of the phototransistors. Similarly, the source of UV radiation 112 may be a plurality of LEDs. Each LED may be embedded in a housing that allows radiation to pass. Such a housing may be doped with organic or inorganic materials to impart filter characteristics to the housing.

Moreover, it is not necessary that filtering be implemented optically. For example, a detector may be constructed to respond to radiation with a wavelength in the range of that passing through detector filter 124. If such a detector is used, detector filter 124 may be omitted. Similarly, a UV radiation source may be constructed to generate UV radiation of wavelengths that pass through source filter 122. If such a source is used, source filter 122 may be omitted.

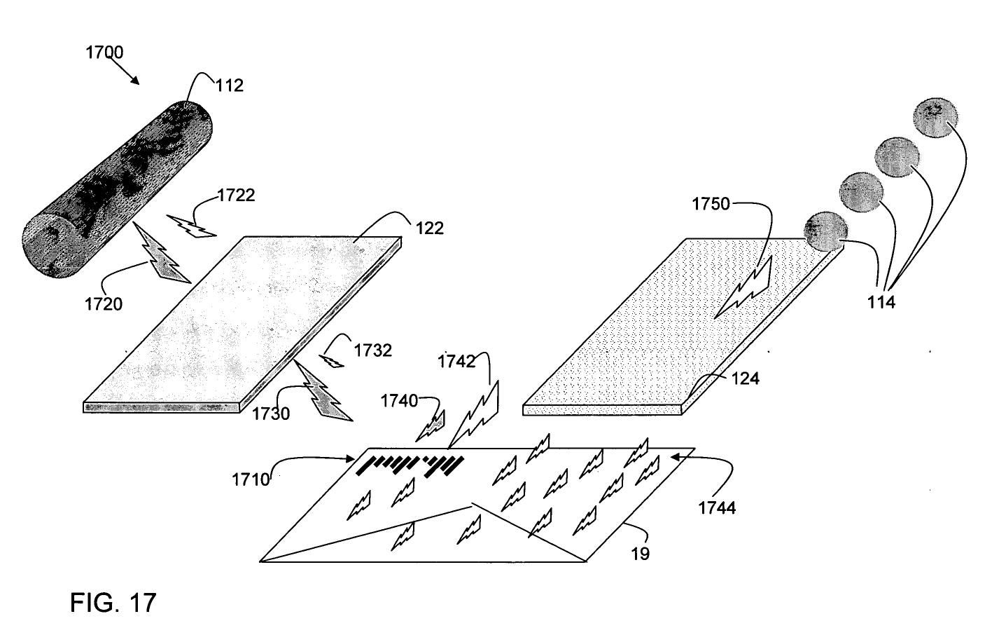

Operation of source filter 122 and detector filter 124 are illustrated in FIG. 17. FIG. 17 shows schematically a UV imaging subsystem 1700 of a mail processing system. UV imaging subsystem includes source filter 122 and detector filter 124. Support structures, baffles and other components of a mail processing system in which UV imaging subsystem 1700 may be used are not expressly shown.

As shown, source filter 122 is positioned between UV radiation source 112 and mailpiece 19 under inspection. Mailpiece 19 may be moved past UV imaging subsystem 1700 on a mail conveyor (not shown) of any suitable design. To form a UV image of mailpiece 19, radiation from UV radiation source 112 passes through source filter 122.

In a mail processing system according to the embodiment of FIG. 17, radiation from UV radiation source 112 irradiates the surface of mailpiece 19. Radiation from radiation source 112 interacts with features, such as barcode 1710 on the surface of mailpiece 19, which causes the feature to emit light that is detected by phototransistors 114, which in this embodiment form a detector array. Barcode 1710 may be printed in fluorescent, phosphorescent or scintillating ink such that when it is radiated with UV light it emits visible light that may be detected. However, UV imaging subsystem 1700 may be used in connection with any features that react to UV light, regardless of how formed.

As shown, radiation from UV radiation source 112 includes multiple components of radiation of different wavelengths. Component 1720 represents radiation falling in the UV spectrum, which may in some embodiments be between about 40 and 400 nm. Component 1722 represents radiation falling in the visible light spectrum, which may in some embodiments be between about 400 nm and 700 nm.

In the illustrated embodiment, source filter 122 is a short pass filter with a cutoff wavelength above that of component 1720 and below that of component 1722. The cutoff wavelength of a short pass filter represents a wavelength of radiation which filter 122 attenuates by half as the radiation passes through the filter. Radiation of shorter wavelength is passed with less attenuation and radiation of longer wavelength is passed with more attenuation. Accordingly, component 1720 passes through filter 122 with little change, and FIG. 17 shows a component 1730 leaving source filter 122 that is similar to component 1720. In contrast, component 1720 has a wavelength above the cutoff wavelength of source filter 122. Accordingly, FIG. 17 shows a component 1732 leaving source filter 122 that may also have a wavelength in the visible light spectrum but is significantly attenuated relative to component 1720.

Regardless of the exact spectrum, radiation leaving source filter 122 interacts with mailpiece 19. In the illustrated embodiment, it is desired for UV imaging subsystem 1700 to form an image of features, such as bar code 1710, on mailpiece 19. As shown, component 1730 has a wavelength that interacts with the ink in barcode 1710, causing it to fluoresce, phosphoresce, scintillate or otherwise give off visible light. Visible light given off by barcode 1710 is represented by component 1742. Component 1742 will have a spectrum that depends on the nature of the ink used to form barcode 1710. As an example, component 1742 may have a spectrum centered around approximately 650 mm.

Regardless of the specific spectrum of component 1742, detector filter 124 may be constructed to pass component 1742. Accordingly, FIG. 17 shows a component 1750 passing through detector filter 124 to reach phototransistors 114, acting as a detector array.

Component 1750 represents a signal that is to be acquired by the detector array to form a UV image. Other components of light emanating from mailpiece 19, or otherwise in the ambient environment, represent noise. Sources of noise illustrated in FIG. 17 include UV radiation reflected mailpiece 19. Reflected UV radiation is illustrated by component 1740. In addition, visible light may be reflected from mailpiece 19. Such reflected visible light may stem from visible light from UV radiation source 112 that passes through source filter 122, such as component 1732, striking the surface of mailpiece 19. However, visible light from any source, including the ambient environment may be reflected from mailpiece 19. Additionally, visible light may emanate from mailpiece 19 as a result of interactions between UV radiation component 1730 and the surface of mailpiece 19. For example, mailpiece 19 may be made of a material that fluoresces. All visible light, other than that emanating from barcode 1710, is represented in FIG. 17 by components 1744.

In the pictured embodiment, detector filter 124 preferentially passes light having a spectrum similar to that component 1742. Detector filter 124 has a cutoff wavelength that blocks or significantly attenuates components, such as components 1740 and 1744, that are not used in forming a UV image. Consequently, the radiation captured by phototransistors 114 more accurately represents features on mailpiece 19 that react to UV radiation.

Though, the precise spectrum of component 1742 is not a limitation on the invention, in the illustrated embodiment, component 1742 has a wavelength at the long end of the visible spectrum. Accordingly, detector filter 124 may be a long pass filter. In some embodiments, detector filter 124 is orange or yellow. However, any suitable filter may be used.

In the illustrated embodiment, detector filter 124 is a long pass filter with a cutoff wavelength below that of component 1742 and above that of components 1740 and 1744. The cutoff wavelength of a long pass filter represents a wavelength of radiation that the filter attenuates by half as the radiation passes through the filter. Radiation of longer wavelength is passed with less attenuation and radiation of shorter wavelength is passed with more attenuation. Accordingly, component 1742 passes through detector filter 124 with little change, and FIG. 17 shows a component 1750 leaving detector filter 124 that is similar to component 1742. In contrast, components 1740 and 1744 have a wavelength below the cutoff wavelength of detector filter 124 and those components will be attenuated in detector filter 124. Accordingly, FIG. 17 shows that those components do not reach phototransistors 114.

In some embodiments, source filter 122 has a cutoff wavelength that is below 450 nm and detector filter 124 has a cutoff wavelength that is above 400 nm. In embodiments, source filter 122 has a cutoff wavelength that is below 420 nm and detector filter 124 has a cutoff wavelength that is above 400 nm. However, the specific cutoff wavelengths selected for source filter 122 and detector filter 124 may depend on the specific features of a mailpiece to be imaged. For example, in embodiments in which it is desired to image IBI and meter marks, source filter 122 may have a cutoff wavelength of about 410 nm and detector filter 124 may have a cutoff wavelength of about 620 nm. In embodiments in which it is desired to image stamps, source filter 122 may have a cutoff wavelength of about 300 nm and detector filter 124 may have a cutoff wavelength of about 400 nm. In embodiments in which it is desired to image stamps, IBI and meter marks, source filter 122 may have a cutoff wavelength of about 390 nm and detector filter 124 may have a cutoff wavelength of about 500 nm.

Though source filter 122 is described as a short pass filter, the invention is not limited to a filter that passes all wavelengths below the cutoff wavelength and blocks all wavelengths above the cutoff wavelength. As used herein, a short pass filter may be any filter that passes, without significant attenuation, at least some components with wavelengths intended to interact with a feature on mailpiece 19 and provides significant attenuation to at least some of the components at wavelengths not intended to interact with a feature on mailpiece 19 while a UV image is formed. The range of wavelengths over which the filter has the desired transmission properties may be limited by other components of UV imaging subsystem 1700. For example, a material may operate as a short pass filter if it has the desired transmission properties for wavelengths that may be generated by UV source 112 and that can be detected by phototransistors 114.

Likewise, detector filter 124 is described as a long pass filter, but the invention is not limited to a filter that passes all wavelengths above the cutoff wavelength and blocks all wavelengths below the cutoff wavelength. As used herein, a long pass filter may be any filter that passes, without significant attenuation, at least some components with wavelengths generated by the interaction of radiation from a source with a feature on mailpiece 19 and provides significant attenuation to at least some of the components at wavelengths otherwise emanating from the surface of mailpiece 19 while a UV image is formed. The range of wavelengths over which the filter has the desired transmission properties may be limited by other components of UV imaging subsystem 1700. For example, a material may operate as a long pass filter if it has the desired transmission properties for wavelengths that may be generated by UV source 112 and that can be detected by phototransistors 114.

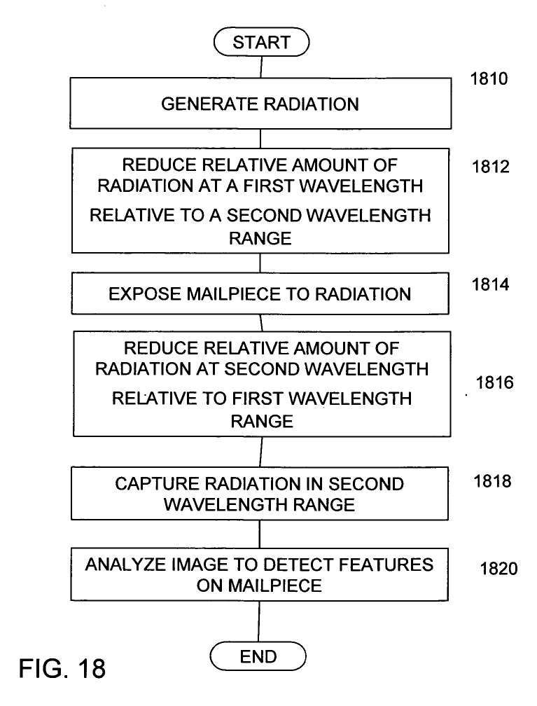

A mail processing system using a UV imaging subsystem 1700 may be operated to process mail according to the process of FIG. 18. The process begins at block 1810 where radiation is generated. The radiation generated may have components in at least a first range of wavelengths and a second range of wavelengths. In the example described above, the first range of wavelengths corresponds to UV radiation and the second range corresponds to visible light. However, these ranges are appropriate based on the nature of features to be detected on the surface of mailpiece 19 and a system may be constructed to operate on any suitable ranges of radiation.

At block 1812, the radiation is filtered to reduce the amount of radiation in the second range relative to radiation in the first range.

At block 1814, a mailpiece is exposed to the filtered radiation.

At block 1816, radiation emanating from the mailpiece is filtered to reduce the relative amount of radiation in the first range relative to the second range. Block 1816 represents an optional step. Omitting this step may be regarded as omitting detector filter 124.

At block 1818, radiation emanating from the mailpiece under inspection is captured.

At block 1820, the captured radiation is analyzed to identify features on the mailpiece under inspection. The specific processing performed at block 1820 may depend on the specific functions of the mail processing system in which the process is performed. For example, processing may involve detecting the orientation of the mailpiece based on the location of a scintillating or fluorescent feature on the mailpiece. The processing may be based on identifying an image of one or more of a stamp, a meter mark, an information-based indicia and an identification tag.

The processing at block 1820 may include further analysis of the features once identified. For example, once the location of a stamp is identified, a gray scale image of the stamp may be analyzed to determine the amount of postage affixed to the mailpiece under inspection. Further analysis may be performed on the image acquired by UV imaging subsystem 1700 or other images, such as those acquired by a gray scale imaging subsystem.

In some embodiments, processing at block 1820 will be based on a low resolution image of the mailpiece, such as is shown in FIGS. 11, 13 and 15. For example, the image may be formed from a detector array having individual detectors spaced on a pitch between about 8.2 mm and 3 mm. Such a low resolution, in combination with filtering as described above, allows rapid and accurate feature detection with low cost components. Further, the computation required to form and analyze such an image is sufficiently low that it can be performed as the mailpiece moves through the mail processing system at rates that may be in excess of 3.5 m/sec and, in some embodiments, may be on the order of 4 m/sec.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A mail processing system comprising:
a) a mail conveyor;
b) an array of detector elements facing the mail conveyor;
c) a radiation source directed at the mail conveyor, the radiation source adapted to emit ultraviolet radiation; and
d) a short pass filter positioned between the radiation source and the mail conveyor.

2. The mail processing system of claim 1, further comprising:
e) a long pass filter between the mail conveyor and the array of detectors.

3. The mail processing system of claim 1, further comprising:
e) a data processor coupled to the array of detector elements, the data processor adapted to produce an image of a mailpiece.

4. The mail processing system of claim 1, wherein the array consists essentially of a linear array.

5. The mail processing system of claim 1, wherein the radiation source comprises a mercury vapor fluorescent tube.

6. The mail processing system of claim 1, wherein the detector elements in the array are disposed on a pitch of between about 3 mm and about 10 mm.

7. The mail processing system of claim 1, further comprising a wear plate disposed between the short pass filter and the mail conveyor.

8. The mail processing system of claim 7, wherein the short pass filter is made of glass or plastic.

9. The mail processing system of claim 8, wherein the wear plate has a surface angled relative to the conveyor by an angle of between 2 degrees and 10 degrees, the surface having at least one aperture and the short pass filter is mounted in the at least one aperture.

10. A mail processing system comprising:
a) a mail conveyor;
b) an array of detector elements facing the mail conveyor;
c) a radiation source directed at the mail conveyor, the radiation source adapted to emit ultraviolet radiation;
d) a short pass filter having a cutoff wavelength below about 450 nm positioned between the radiation source and the mail conveyor; and
e) a long pass filter having a cutoff wavelength above about 400 nm positioned between the mail conveyor and the array of detector elements.

11. The mail processing system of claim 10, further comprising a support structure, wherein the array of detector elements, the radiation source, the short pass filter and the long pass filter are mounted to the support structure.

12. The mail processing system of claim 10, wherein the short pass filter has a cutoff wavelength of about 390 nm and the long pass filter has a cutoff wavelength of about 500 nm.

13. The mail processing system of claim 10, wherein the long pass filter is orange or yellow.

14. A method of operating a mail processing system, comprising:
a) generating radiation having components in at least a first and second wavelength range;
b) filtering the radiation to reduce the portion of radiation in the second wavelength range relative to the first wavelength range;
c) exposing a mailpiece to the filtered radiation; and
d) capturing an image of the mailpiece using radiation in the first wavelength range.

15. The method of claim 14, further comprising:
e) before capturing the image, filtering radiation emanating from the mailpiece to reduce the proportion of radiation in the first wavelength range relative to the second wavelength range.

16. The method of claim 14, wherein capturing an image comprises capturing scintillating features on a surface of the mailpiece in the image.

17. The method of claim 16, further comprising determining the orientation of the mailpiece based on the location of the scintillating features in the image.

19. The method of claim 18, wherein determining the orientation comprises identifying the one or more of a stamp, a meter mark, an information-based indicia and an identification tag.

20. The method of claim 14, wherein capturing an image comprises capturing a low resolution image.
